(19) United States
(12) Patent Application Publication
(10) Pub. No.: US 2015/0338304 A1
(43) Pub. Date: Nov. 26, 2015

(54) ALGORITHM FOR DETECTING ACTIVATION OF A PUSH BUTTON

(71) Applicants: Pierre-Benoît PRUD'HOMME, Strasbourg (FR); Julien CHARRIER, Niederhausbergen (FR); DELPHI TECHNOLOGIES, INC., Troy, MI (US)

(72) Inventors: PIERRE-BENOIT PRUD'HOMME, STRASBOURG (FR); JULIEN CHARRIER, NIEDERHAUSBERGEN (FR)

(21) Appl. No.: 14/652,227

(22) PCT Filed: Dec. 27, 2012
(86) PCT No.: PCT/EP2012/076997

§ 371 Date: Jun. 15, 2015

(51) Int. Cl. G01L 25/00; G01L 1/20; G06F 3/01

(52) U.S. Cl. CPC G01L 25/00; G06F 3/016; G01L 1/20

(57) ABSTRACT

The invention relates to an algorithm for detecting activation of a tactile pressure sensor having a mechanic structure, acquisition electronics, and a specific sensor behavior. The algorithm includes (a) measuring an input quantity (f₀) corresponding to a force applied on the tactile pressure sensor with determined environmental condition; (b) computing a corrected activation threshold (Δf_{COR}) based on a calibrated activation threshold (Δf_{CAL}) evaluated during calibration of the tactile pressure sensor corrected by an electronic correction factor (CF_{ELEC}) for adjusting acquisition electronics variability, a mechanical correction factor (CF_{MECHA}) for adjusting mechanic structure variability and a sensor correction factor (CF_{FSR}) for adjusting sensor variability; the determined environmental condition; and an idle quantity (f_{idle}) based on the quantity measured when the tactile pressure sensor is not pressed under the determined environmental condition; (c) comparing the measured input quantity with the corrected activation threshold to determine whether the sensor has been pressed or not.

### CROSS-REFERENCE TO RELATED APPLICATION

This application claims the benefit under 35 U.S.C. §371 of published PCT Patent Application Number PCT/EP 2012/076997, filed Dec. 27, 2012, and published as WO2014/101946 on Jul. 3, 2014, the entire contents of which is hereby incorporated by reference herein.

### TECHNICAL FIELD OF INVENTION

The present invention relates to an algorithm for detecting activation of a push button comprising a tactile pressure sensor. Such algorithm is applicable to all products that contain FORCE SENSING RESISTOR® (FSR) technology working in preloaded condition and how to control the force to detect sensor activation through a rigid mechanical part (e.g. detect activation above a specified actuation force, regardless the velocity of the actuation).

### BACKGROUND OF INVENTION

FSR® Integration Guide & Evaluation Parts Catalog With Suggested Electrical Interfaces, which is enclosed herewith by reference, provides an overview of the Force Sensing Resistors technology along with some basic electrical interfaces using such FSRs. In particular, FIG. 17 of this document shows an FSR current-to-voltage converter described by the following equation:

V_{OUT}=V_{REF}/2×[1+RG/R_{FSR}]

Another example is given in FIG. 18 of this document showing a simple force to frequency converter with an FSR device as the feedback element around a Schmitt trigger. At zero force, the FSR is an open circuit. Depending on the last stage of the trigger, the output remains constant, either high or low. When the FSR is pressed, the oscillator starts, its frequency increasing with increasing force.

In existing solutions, electronic measures, through a microprocessor Analogic Digital Converter (ADC), a voltage, or frequency that will be the image of the FSR resistance/pressure. As the FSR resistance variation is assumed to follow a 1/F law, F being the force applied, thus the output voltage or frequency is a straight line as shown on FIGS. 1B and 1C.

The relation between the pressure applied on FSR and the resistance variation is given on FIG. 1A. Therefore, theoretically whatever the resistance is, for a constant force ΔF, there is constant voltage ΔV as shown in FIG. 1B or a constant frequency Δf as shown in FIG. 1C.

Mainly used algorithms are generally based on high pass filter with long time constant (16 samples @ 20 ms sampling period). Further, the output value of this filter that depends on the velocity and force of the actuation is compared to thresholds for detecting any change on the sensor.

It is further known from the document WO 2012/004370, an algorithm for detecting actuation of a tactile pressure sensor. As it can be seen on FIG. 2, it represents schematically the sensor processing means to detect actuation. An input quantity such as a voltage (V₀) or a frequency (f₀) will be periodically measured at the input (V/f_FSR_Linear) of an analogic to digital converter (ADC Driver) for a voltage or of a timer input for a frequency. In order to define a current idle quantity (V_{idle}; f_{idle}) depending on the measured input quantity when the sensor is not pressed, it is provided with filtering means such as a low-pass filter (LPF) for filtering said input quantity. It further comprises press and release threshold calculation means for computing an activation threshold (ΔV_{P}; Δf_{P}) for detection when the sensor is pressed and also preferably a non-activation threshold (ΔV_{R}; Δf_{R}) for detection when the sensor is released based on this defined idle quantity and on a corresponding quantity characterization of the sensor mechanic structure. Finally it comprises push state calculation means comparing the sensor input quantity (V₀, f₀) with the last defined idle quantity (V_{idle}; f_{idle}) and the activation/non-activation thresholds (ΔV_{P}/ΔV_{R}, Δf_{P}/ΔVf_{R}) in order to determine whether the sensor is pressed or not. At the output, a push state is delivered.

Although such algorithm with idle frequency computing makes the sensor more independent from slowly changing environmental factors (such as temperature changes, mechanical warping), the sensor is however used under preload conditions so that several contributors lead to system uncertainties. These contributors are acquisition electronics, sensor behavior and mechanics.

Commonly used method to manage this dispersion is a calibration process that occurs during end of line testing (EOLT). Thus, it is possible to easily change the sensitivity of the system and make it possible to detect an actuation for a modifiable threshold. During calibration process, the frequency deviation that appears under the desired activation force (F1) is measured. This frequency deviation (Δf) is the activation threshold and is stored in a non-volatile memory (NVM).

At this stage, the assumption is made that whatever the idle frequency is, the frequency deviation under the activation force is constant.

∀f_{idle},Δf=cst

Some temperature effects are currently considered. In order to make the system less sensitive to temperature variation, correction factors depending on temperature levels are stored in a Look Up Table (LUT).

For example:

| | Temperature range(° C.) | | | | |
|---|---|---|---|---|---|
| | below | −20° C. to | 0° C. to | 40° C. to | above |
| | −20° C. | 0° C. | 40° C. | 60° C. | 60° C. |
| Temp. | 0.82 | 0.92 | 1 | 1.15 | 1.35 |
| Coefficient | | | | | |

Then the actuation threshold is given by the nominal frequency deviation (Δf) multiplied by the temperature coefficient.

With preloaded tactile sensors, this calibration approach leads to several drawbacks.

First, the whole system (electronics, mechanics, FSR sensor) cannot be characterized on the whole preload range. The frequency deviation can only be measured at the preload obtained after assembly (FIG. 3A). So necessarily assumption is made that frequency deviation is constant whatever the preload level is. In other words, slope of the system must be constant whatever the environmental conditions are. On FSR sensor level this assumption is actually weak as it is shown on FIG. 3B. Indeed, as preload changes during the whole product lifetime, FSR sensor response changes and thus the activation threshold becomes inappropriate.

Second, calibration process implies necessarily the linearity hypothesis: system response must have a constant slope. For electromagnetic compatibility (EMC) reason, specific filtering may be added into the electronics that add non-linearity as shown in FIG. 4. Consequently non-linearity is an inaccuracy of the detection threshold in comparison with the target threshold. To prevent this issue, previous solutions recommend characterization of the whole system all over the preload range, which is inappropriate for preloaded sensors.

Third, temperature effect has an impact on the system response. In order to compensate temperature variability, current solution is based on LUT that has finite resolution and provides few design flexibility. Thus accuracy of compensation is poor and may imply detection threshold inaccuracy. Moreover, temperature may also have interactions with some other variability parameters. For example, variability of the system due to preload may be different between two different temperatures. That kind of interaction is not taking into account in existing solutions. Then compensation strategies are necessarily inaccurate. These drawbacks render impossible to fulfill the following requirements: triggering an activation under a definite force threshold with an acceptable accuracy under all environmental conditions.

Fourth, from a mechanical perspective, temperature may have an impact on the proportion of force transmitted by the mechanics to the FSR sensor. Then, for the same force applied by the user, FSR solicitation may be different from one temperature to another. On current solutions, as activation triggering depends on a fixed calibration threshold, activation force may be inaccurate.

### SUMMARY OF THE INVENTION

One goal of the present invention is to overcome the aforecited drawbacks by providing an algorithm for reliably detecting activation of a tactile pressure sensor while fulfilling system requirements and being independent of product use context more especially to provide accurate detection under all environment conditions including temperature range and preload range.

For that purpose, according to a first aspect of the invention, it is proposed a new algorithm for detecting activation of a tactile pressure sensor having a mechanic structure, acquisition electronics and a specific sensor behavior comprising the steps consisting of (a) measuring an input quantity corresponding to a force applied on the tactile pressure sensor with determined environmental condition; (b) computing a corrected activation threshold based on an activation threshold evaluated during calibration of the tactile pressure sensor corrected by an electronic correction factor for adjusting acquisition electronics variability, a mechanical correction factor for adjusting mechanic structure variability and a sensor correction factor for adjusting sensor variability, on the determined environmental conditions; and on an idle quantity based on the quantity measured when the tactile pressure sensor is not pressed under said determined environmental conditions; and (c) comparing the measured input quantity with the corrected activation threshold to determine whether the sensor has been pressed or not.

Such algorithm ensures that all variability factors depending on the acquisition electronic, the mechanic structure and the sensor behavior are taken into account to determine whether the sensor has been pressed or not. More specifically, this algorithm provides a smart compensation strategy to compensate the different variability factors.

According to a preferred embodiment, the electronic correction factor is based on characterization of the acquisition electronics on temperature and frequency ranges. More preferably, the electronic correction factor is calculated as the deviation between measured slopes during said characterization on temperature and frequency ranges and a nominal slope defined by the calibration threshold in nominal conditions. Such electronic correction factor prevents inaccuracy of activation triggering due to acquisition electronics such as non-linearity and sensitivity to temperature change. It further provides smart compensation strategy to compensate variability due to acquisition electronics non-linearity over preload and temperature range.

According to another embodiment, the mechanical correction factor is based on characterization of force transmission rates of the mechanic structure over time and on temperature range. More preferably, the mechanical correction factor is calculated as the deviation between measured force transmission rates during said characterization on temperature range and a nominal force transmission rate defined by the calibration threshold in nominal conditions. Such mechanical correction factor prevents inaccuracy of activation triggering due to mechanics such as force transmission rate variability due to temperature change as well as sensitivity to temperature change. It further provides smart compensation strategy to compensate variability due to mechanical changes over time and temperature range.

According to another embodiment, the sensor correction factor is based on sensor behavior characterization on temperature and preload ranges. More preferably, the sensor correction factor is calculated as the deviation between measured average slopes during said characterization on temperature and frequency ranges and a nominal average slope defined by the calibration threshold in nominal conditions. Such sensor correction factor prevents inaccuracy of activation triggering due to sensor variability such as sensitivity to temperature change and sensitivity to preload change. It further provides smart compensation strategy to compensate variability due to FSR sensor behavior changes over preload and temperature range.

According to another embodiment, the electronic and sensor correction factors are stored in 2D lookup tables and the mechanic correction factor is stored in a simple lookup table. Use of such lookup tables is simple and convenient to track variations of the different correction factors with one or more parameters. For instance, variation of the electronic correction factor will be stored on all temperature range and on all frequency range. Variation for the mechanic correction factor will be stored on all temperature rate. And variation of the sensor correction factor will be stored on all temperature range and all preload range.

According to an alternative embodiment, the different correction factors are calculated on the fly based on the temperature, the idle frequency and predetermined constant values. Such calculation on the fly provides higher resolution.

According to another embodiment, the calibration activation threshold is calculated based on a measured calibration threshold corrected by electronic, mechanic and sensor calibration correction factors defined at determined calibration environmental conditions. Use of correction factors also for determination of the calibration activation threshold during calibration process further improves accuracy of said activation threshold

According to another embodiment, the calibrated activation threshold is determined specifically for each product depending on the mechanical structure of the sensor. Such specificity further increases accuracy for the activation threshold.

According to another embodiment, a minimum activation threshold is applied when the correction factors lead to a corrected activation threshold lower than said minimum activation threshold. Such minimum activation threshold is provided to avoid unexpected activation when correction factors results in a very low corrected activation threshold. This approach permits to maintain a correction strategy as long as possible.

According to a second aspect, the present invention concerns a tactile pressure sensor having a mechanic structure, acquisition electronics and a specific sensor behavior, arranged to operate according to the algorithm of the first aspect. Such tactile pressure sensor allows for reliably detecting activation while fulfilling system requirements and being independent of product use context more especially to provide accurate detection under all environment. Preferably, the tactile pressure sensor is a force sensing resistor.

According to a third aspect, the invention concerns a push button comprising a tactile pressure sensor according to the second aspect controlled by the algorithm according to the first aspect.

Further features and advantages will appear more clearly on a reading of the following detailed description of the preferred embodiment, which is given by way of non-limiting example only and with reference to the accompanying drawings.

### BRIEF DESCRIPTION OF DRAWINGS

Other features and advantages of the invention will appear upon reading the following description which refers to the annexed drawings in which:

FIG. 1A, already described, is a graphic showing the relation between pressure applied on FSR and its resistance;

FIG. 1B, already described, is a graphic showing the relation between pressure applied on FSR and voltage variation;

FIG. 1C, already described, is a graphic showing the relation between pressure applied on FSR and frequency variation;

FIG. 2, already described, represents the sensor processing means according to the prior art;

FIG. 3A, already described, is a graphic showing the frequency deviation of the FSR measurement under preload;

FIG. 3B, already described, is a graphic showing slope measurement with respect to preload;

FIG. 4, already described, is a graphic showing FSR driver mislinearity with and without filtering;

FIG. 5 represents a diagram of the algorithm for detecting activation of a tactile pressure sensor based on a frequency quantity acquisition;

FIG. 6 represents a computation diagram of the threshold for detecting activation of a tactile pressure sensor according to a preferred embodiment of the invention;

FIG. 7A represents the frequency and temperature characterization of the acquisition electronics variability;

FIG. 7B represents the frequency and temperature characterization of the sensor behavior variability;

FIG. 8A represents the frequency characterization of the calibration electronic correction factor; and

FIG. 8B represents the frequency characterization of the sensor behavior.

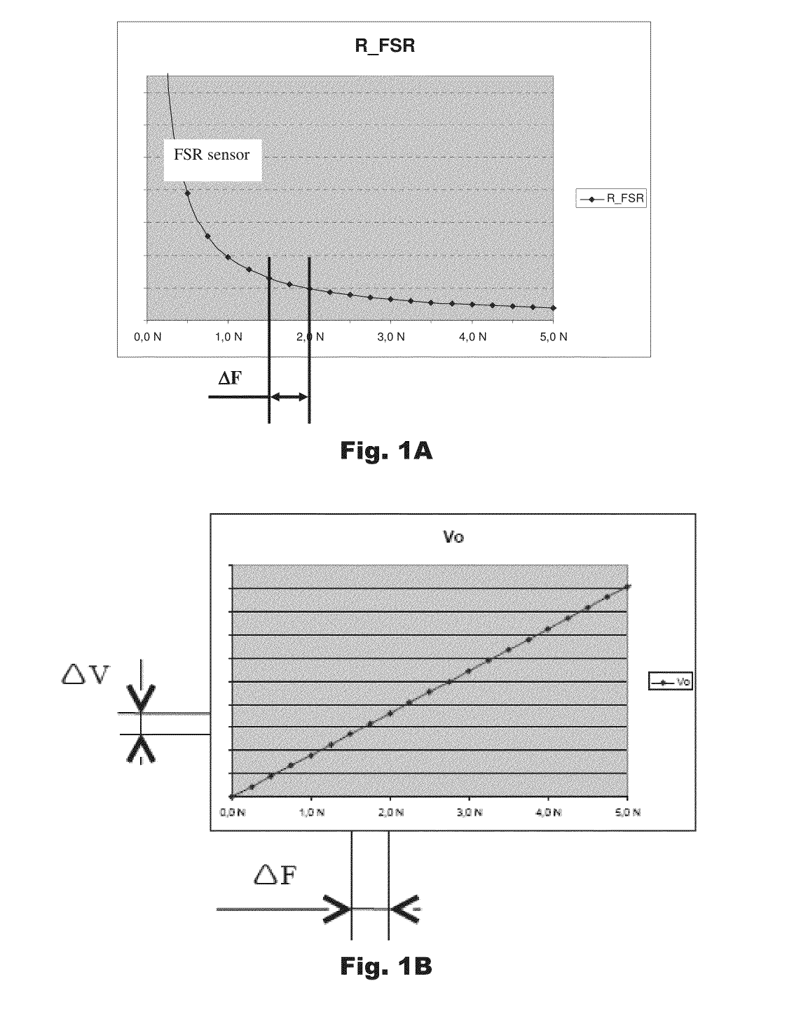

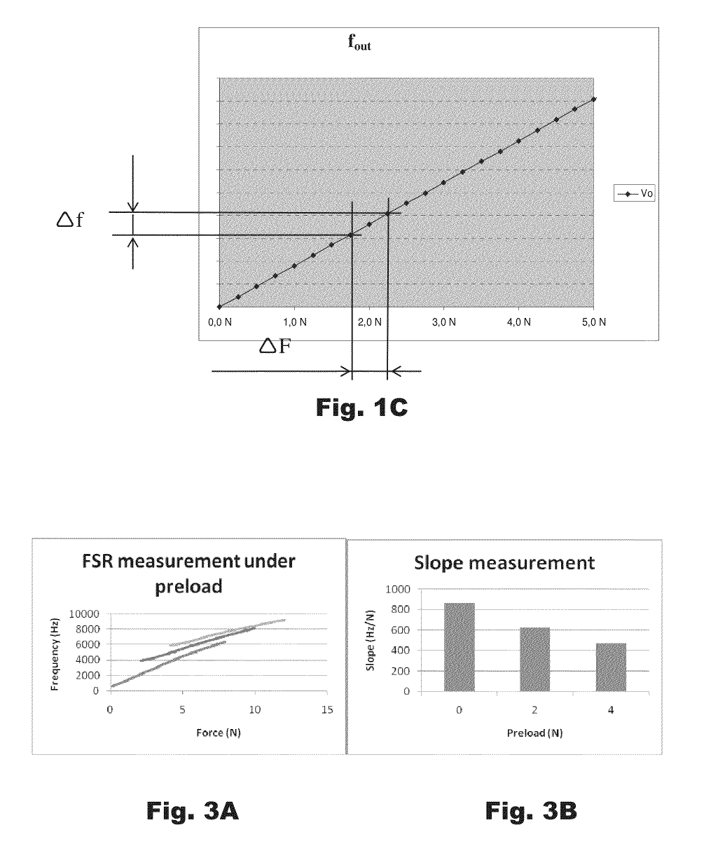

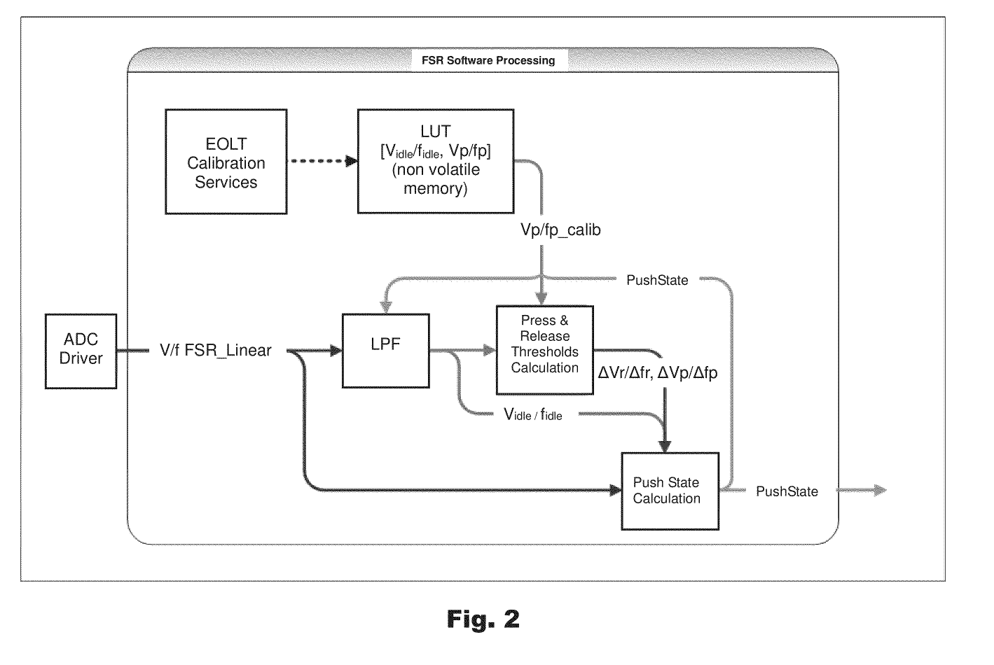

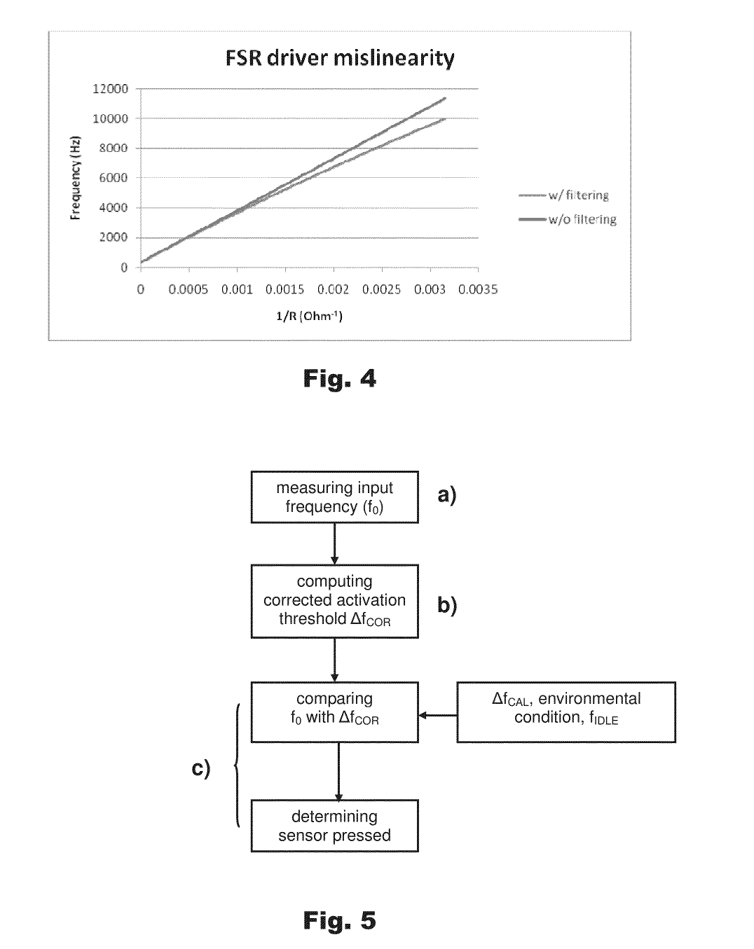

### DETAILED DESCRIPTION

With reference now to FIGS. 5 to 8B, we will describe in more details several embodiments of an algorithm for detecting the activation of a tactile pressure sensor, such as for instance a force sensing resistor sensor.

According to a preferred embodiment, it is provided to use a force sensing resistor (FSR) driver that generates a periodic square signal which frequency is related to 1/R_{FSR}. Frequency acquisition has preferably to be performed by a microprocessor thanks to an input capture pin. In this case, FSR driver supplies a digital output, which is much more robust to EMC perturbations and permits to use remote sensors.

FIG. 5 represents a diagram of the algorithm for detecting activation of a tactile pressure sensor based on a frequency quantity acquisition. Alternatively, this can be done on any other suitable quantity acquisition such as voltage quantity acquisition.

A first step a) consists in measuring an input frequency (f₀) corresponding to a force applied on the tactile pressure sensor with determined environmental condition.

A second step b) consists in computing a corrected activation threshold (Δf_{COR}) based on a calibrated activation threshold (Δf_{CAL}), the determined environmental condition, and an idle frequency (f_{IDLE}) based on the frequency measured when the tactile pressure sensor is not pressed under the determined environmental condition.

A third step c) consists in comparing the measured input frequency (f₀) with the corrected activation threshold (Δf_{COR}) to determine whether the sensor has been pressed or not.

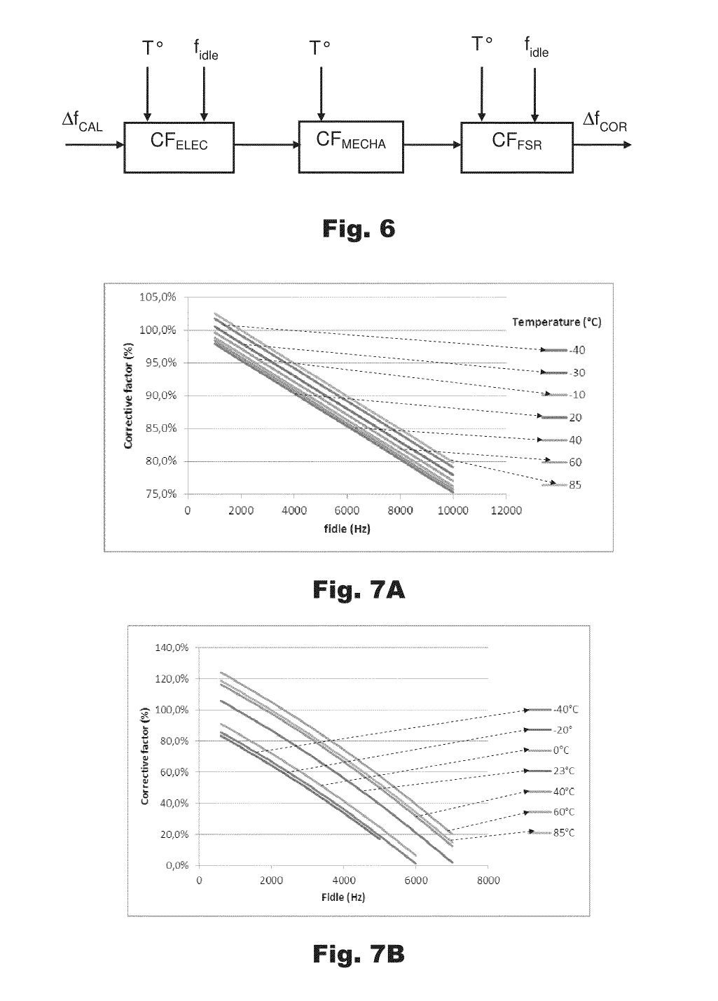

FIG. 6 represents a computation diagram of the threshold for detecting activation of a tactile pressure sensor according to a preferred embodiment of the invention. Starting from the frequency threshold (Δf_{CAL}) evaluated during the calibration process, several correction factors are applied to take into account system variability.

To correct acquisition electronics non-linearity, an electronic correction factor (CF_{ELEC}) calculated or stored in lookup table is used. Such electronic correction factor (CF_{ELEC}) is based on electronic drivers characterization over preload and temperature range. To correct mechanical changes, a mechanical correction factor (CF_{MECHA}) calculated or stored in lookup table is used. Such mechanical correction factor (CF_{MECHA}) is based on the mechanical characterization over time and temperature range. To correct FSR sensor behavior changes, a FSR sensor correction factor (CF_{FSR}) calculated or stored in lookup table is used. Such FSR sensor correction factor (CF_{FSR}) is based on FSR sensor characterization over preload and temperature range. The result for applying these correction factors is to obtain a corrected frequency threshold (Δf_{COR}) to ensure constant activation triggering.

We will now consider in more details examples of threshold adjustment against electronics variability, mechanic variability and FSR sensor variability.

In order to prevent inaccuracy of activation triggering due to acquisition electronics, such as non-linearity and sensitivity to temperature change, it is proposed to make the characterization of the acquisition electronics on all temperature range, and on all frequency range. Characterization includes local slopes evaluation. Measured local slopes values (in all conditions) are then compared to nominal values (in nominal condition), and corrective factors may be calculated to compensate deviation from the nominal value.

Electronic correction factor may be calculated as follow:

$${CF}_{ELEC} ( \% ) = \frac{{Slope}_{Measured}}{{Slope}_{Nominal}} \qquad ( 1 )$$

So the deviation of the slope, according to the temperature) (T°) and the idle frequency (f_{idle}) is integrated by the algorithm via a curve stored in a non-volatile memory (NVM), and the calibration threshold (Δf) which stands for the slope in nominal conditions, is also stored in NVM and can be specific for each product depending on the mechanical structure.

Then the calibration threshold (Δf) may be adjusted by the appropriate electronic correction factor. Such electronic correction factors are represented in FIG. 7A depending on the idle frequency and the temperature range and may be stored in a 2D lookup table or be calculated on the fly thanks to a predetermined equation that provides highest resolution.

For example, equation for electronic correction factor calculation may be as follow:

CF_{ELEC}=aT°²+bT°+cf_{idle}+d (2)

where a, b, c and d are predefined constant values

In order to prevent inaccuracy of activation triggering due to mechanics such as force transmission rate variability due to temperature change and sensitivity to temperature change, it is proposed to make the characterization of force transmission rates (FTR) of mechanics all over the temperature range. Measured force transmission rate values (in all conditions) are then compared to nominal values (in nominal condition), and mechanic correction factors may be calculated to compensate deviation from the nominal value.

Mechanic correction factor may be calculated as follow:

$${CF}_{mecha} ( \% ) = \frac{{FTR}_{Measured}}{{FTR}_{Nominal}} \qquad ( 3 )$$

So the deviation of force transmission rate according to the temperature is integrated by the algorithm via a curve stored in NVM, and the calibration threshold (Δf) which stands for the force transmission rate in nominal conditions, is also stored in NVM and can be specific for each product depending on the mechanical structure.

Then the calibration threshold (Δf) may be adjusted by the appropriate mechanic correction factor. Such mechanic correction factors depending on the temperature range may be stored in a lookup table or be calculated on the fly thanks to a predetermined equation that provides highest resolution.

For example, equation for mechanic correction factor calculation may be as follow:

CF_{mecha}=aT°+b (4)

where a and b are predefined constant values

In order to prevent inaccuracy of activation triggering due to FSR sensor variability such as sensitivity to temperature change and sensitivity to preload change, it is proposed to make the characterization of the FSR sensors on all temperature range and on all preload range. Characterization consists in the evaluation of the sensor's frequency average slopes in all condition. Measured average slopes values (in all conditions) are then compared to nominal values (in nominal condition), and FSR sensor correction factors may be calculated to compensate deviation from the nominal value.

FSR sensor correction factor may be calculated as follow:

$${CF}_{FSR} ( \% ) = \frac{{Slope}_{Measured}}{{Slope}_{Nominal}} \qquad ( 5 )$$

So sensor's response variability according to the temperature) (T°) and the idle frequency (f_{idle}) (e.g. preload) is integrated by the algorithm via a curve stored in NVM and the calibration threshold (Δf) which stands for the average slope in nominal conditions, is also stored in NVM and can be specific for each product depending on the mechanical structure.

Then the calibration threshold (Δf) may be adjusted by the appropriate FSR sensor correction factor. Such FSR sensor correction factors are represented in FIG. 7B depending on the idle frequency and the temperature range may be stored in a 2D lookup table or be calculated on the fly thanks to a predetermined equation that provides highest resolution.

For example, equation for FSR sensor correction factor calculation may be as follow:

CF_{FSR}=aT°³+bT°²+cT°+ef_{idle}²+ff_{idle}+g (6)

where a, b, c, d, e, f and g are predefined constant values

According to another preferred embodiment of the invention, it is provided to already handle some drawbacks such as electronics mislinearity or sensor response variability under preload during the calibration process of the tactile pressure sensor.

When applying a desired force on the product surface, which can be the sensor surface or a push button including the sensor, a frequency deviation may be measured. But as the product may not be in reference conditions, measured frequency deviation cannot be stored directly in NVM. Correction factors have preferably to be applied in order to determine and store the “reference” calibration threshold (Δf_{CAL}), that would have occurred, if the product had been in reference condition. This correction is expressed as follow:

Δf_{CAL}=CF_{CAL}_{_{—}}_{ELEC}×CF_{CAL}_{_{—}}_{MECHA}×CF_{CAL}_{_{—}}_{FSR}×Δf_{Measured} (7)

These calibration correction factors may be defined at room temperature as calibration environmental conditions are stable. So that the calibration correction factors are expressed as follow:

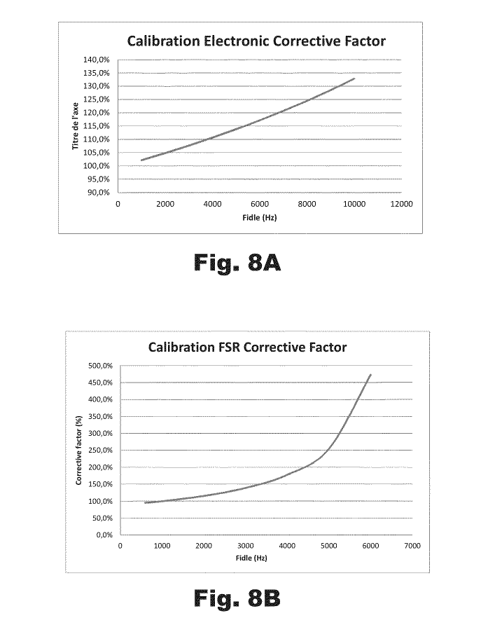

Calibration electronic correction factor as represented in FIG. 8A:

$${CF}_{CAL\_ELEC} = \frac{1}{{CF}_{ELEC}} \qquad ( 8 )$$

Calibration FSR correction factor as represented in FIG. 8B:

$${CF}_{CAL\_FSR} = \frac{1}{{CF}_{FSR}} \qquad ( 9 )$$

Calibration mechanic correction factor:

$${CF}_{CAL\_MECHA} = \frac{1}{{CF}_{MECHA}} \qquad ( 10 )$$

As expressed in relation with FIG. 6, when all correction factors have been determined, activation threshold may be determined using the calibration threshold as follow:

Δf_{COR}=CF_{ELEC}×CF_{MECHA}×CF_{FSR}×Δf_{CAL} (11)

Depending on the environmental conditions, correction factors may vary a lot and be very strong, resulting in a corrected activation threshold that may be very low. Further, EMC factors may increase overall signal noise, so that in severe conditions, low activation threshold may lead to unexpected activation. For that reason, it is preferably proposed to set a minimum value to the computed activation threshold.

If the calculated activation threshold is above this minimum threshold, value used for activation triggering is the calculated value, and activation force will be constant. If the calculated activation threshold is below this minimum threshold, value used for activation triggering is this minimum threshold. In this case, activation force will be higher than expected, but the push will remain functional. Such approach allows to maintain a correction strategy as long as possible.

Having described the invention with regard to certain specific embodiments, it is to be understood that these embodiments are not meant as limitations of the invention. Indeed, various modifications, adaptations, and/or combination between embodiments may become apparent to those skilled in the art without departing from the scope of the annexed claims.

1. An algorithm for detecting activation of a tactile pressure sensor having a mechanic structure, acquisition electronics, and a specific sensor behavior, said algorithm comprising the steps of:
a) measuring an input quantity (f₀) corresponding to a force applied on the tactile pressure sensor with a determined environmental condition;
b) computing a corrected activation threshold (Δf_{COR}) based on a calibrated activation threshold (Δf_{CAL}) evaluated during calibration of the tactile pressure sensor corrected by an electronic correction factor (CF_{ELEC}) for adjusting acquisition electronics variability, a mechanical correction factor (CF_{MECHA}) for adjusting mechanic structure variability, and a sensor correction factor (CF_{FSR}) for adjusting sensor variability,
the determined environmental condition, and
an idle quantity (f_{idle}) based on the quantity measured when the tactile pressure sensor is not pressed under the determined environmental condition; and
c) comparing the measured input quantity with the corrected activation threshold to determine whether the sensor has been pressed or not.

2. The algorithm according to claim 1, wherein the electronic correction factor (CF_{ELEC}) is based on characterization of the acquisition electronics over a temperature range and a frequency range.

3. The algorithm according to 2, wherein the electronic correction factor (CF_{ELEC}) is calculated as a deviation between measured slopes (Slope_{Measured}) during said characterization over the temperature range and the frequency range, and a nominal slope (Slope_{Nominal}) defined by a calibration threshold (Δf) in nominal conditions.

4. The algorithm according to claim 1, wherein the mechanical correction factor (CF_{MECHA}) is based on characterization of force transmission rates of the mechanic structure over time and a temperature range.

5. The algorithm according to claim 4, wherein the mechanical correction factor (CF_{MECHA}) is calculated as a deviation between measured force transmission rates (FTR_{Measured}) during said characterization on the temperature range and a nominal force transmission rate (FTR_{Nominal}) defined by a calibration threshold in nominal conditions.

6. The algorithm according to claim 1, wherein the sensor correction factor (CF_{FSR}) is based on sensor behavior characterization over a temperature range and a preload range.

7. The algorithm according to claim 6, wherein the sensor correction factor (CF_{FSR}) is calculated as a deviation between measured average slopes (Slope_{Measured}) during said characterization on temperature and frequency ranges and a nominal average slope (Slope_{Nominal}) defined by a calibration threshold (Δf) in nominal conditions.

8. The algorithm according to claim 1, wherein the electronic and sensor correction factors (CF_{ELEC}, CF_{FSR}) are stored in 2D lookup tables and the mechanic correction factor (CFMECHA) is stored in a simple lookup table.

9. The algorithm according to any of claim 2, 4 or 6, wherein the correction factors (CFELEC, CFFSR, CFMECHA) are calculated on the fly based on the temperature, the idle frequency and predetermined constant values.

10. The algorithm according to claim 1, wherein the calibrated activation threshold (ΔfCAL) is calculated based on a measured calibration threshold (ΔfMeasured) corrected by electronic, mechanic and sensor calibration correction factors (CFCAL_ELEC, CFCAL_FSR, CFCAL_MECHA) defined at determined calibration environmental conditions.

11. The algorithm according to claim 1, wherein the calibrated activation threshold (ΔfCAL) is specific for each product depending on the mechanical structure of the sensor.

12. The algorithm according to claim 1, wherein a minimum activation threshold is applied when the correction factors lead to a corrected activation threshold (ΔfC) less than said minimum activation threshold.

13. A tactile pressure sensor having comprising:
a mechanic structure,
acquisition electronics, and
a specific sensor behavior and arranged to operate according to claim 1.

14. The tactile pressure sensor according to claim 13, wherein the specific sensor is a force sensing resistor sensor.

15. A push button comprising a tactile pressure sensor according to claim 13.
